(19) United States
(12) Patent Application Publication
(10) Pub. No.: US 2021/0350450 A1
(43) Pub. Date: Nov. 11, 2021

(54) Business Method Using Augmented Reality

(71) Applicant: Soo Ihl Kim, Los Angeles, CA (US)

(72) Inventor: Soo Ihl Kim, Los Angeles, CA (US)

(21) Appl. No.: 16/867,310

(22) Filed: May 5, 2020

(51) Int. Cl. G06Q 30/06; G06F 16/53; G06Q 10/06; G06T 11/60

(52) U.S. Cl. CPC G06Q 30/0643; G06T 11/60; G06Q 10/067; G06F 16/53

(57) ABSTRACT

The present invention provides a business method comprising: uploading a digital content and an input image corresponding to the digital content from an AR provider device to a central processing system via a network; storing the digital content and the input image at the central processing system; scanning a physical depiction of the input image at an end user device; submitting a query for retrieving the digital content corresponding to a scanned image from the physical depiction of the input image from the end user device to the central processing system via the network; retrieving the digital content at the central processing system; fetching the digital content from the central processing system to the end user device via the network, and displaying the digital content overlaid on the scanned image at a display of the end user device.

### FIELD OF THE INVENTION

The present invention pertains generally to the field of a business method, and more particularly to a business method using augmented reality.

### BACKGROUND OF THE INVENTION

Augmented reality technology gives people a new experience of a real-world environment enhanced by computer-generated input such as images, graphics, videos, sounds, or GPS data. This technology is based on computing devices including a processor, a display, a sensor, and an input device.

Meanwhile, modern mobile electronic devices, such as smart phones, enable people to access a tremendous amount of information or various types of digital contents through internet.

Accordingly, business owners use internet to provide information regarding their businesses to their potential clients. However, while customers search the internet to obtain more information of products or service, this process takes their time and they may reach to wrong or insufficient contents.

### SUMMARY OF THE INVENTION

The present invention provides a business method using augmented reality. The business method enables business owners to provide business information consisting of various types of digital contents to their potential clients through their service items. Also, this business method provides customers to obtain new and lively experiences as well as accurate information regarding products or services.

Embodiments of the inventive concept provide a business method comprising: uploading a digital content and an input image corresponding to the digital content from an AR provider device to a central processing system via a network; storing the digital content and the input image at a storage memory of the central processing system; scanning a physical depiction of the input image at an image sensor of an end user device; submitting a query for retrieving the digital content corresponding to a scanned image from the physical depiction of the input image from the end user device to the central processing system via the network; retrieving the digital content at the central processing system; fetching the digital content from the central processing system to the end user device via the network, and displaying the digital content overlaid on the scanned image at a display of the end user device.

In one embodiment, between the uploading and the storing, the method further comprises editing the digital content at an editor of the central processing system.

In one embodiment, the editing comprises at least one of adding more contents, modifying, coloring, resizing, and filtering the digital content.

In one embodiment, the editing is performed while overlaying the digital content on the input image.

In one embodiment, between the receiving the query and the retrieving the digital content, the method further comprises: filtering the scanned image of the query at the central processing system and searching the digital content with the filtered scanned image at the central processing system.

In one embodiment, the central processing system process both a query from the AR provider and the query from the end user device.

In one embodiment, the central processing system, the image sensor, and the display are connected to each other through an AR application loaded on the end user device.

In one embodiment, the displaying further comprises interacting with, exploring, rotating, and zooming the digital content by tapping, scrolling, and swiping the display.

In one embodiment, the input image is a real world image comprising at least one of arts, paintings, pictures, galleries, sculptures, photography, a business card, an invitation card, posters, books, magazines, comics, advertisements, and newspaper.

In one embodiment, the input image is a live feed.

In one embodiment, the digital content comprises at least one of visual content, audio content, haptic content, a real-world environment, and an augmented reality environment.

In one embodiment, the digital content comprises at least one of a virtual or digital content, a three dimensional object, two dimensional object, animation, a video with audio, text, annotation, music, sound clips, audio recordings, a map, a navigation map, and a virtual art gallery.

In one embodiment, the digital content is adjusted with a rotation, a movement, and a scale with respect to a live view of the imaging sensor.

In one embodiment, the input image is a business card, and the digital content comprises at least one of business introduction videos, product demo videos, an address with navigation details, a direct contact, an email, and a company website.

In one embodiment, the input image is an artwork, and the digital content comprises at least one of an introduction video about an artist of the artwork, an artwork making video, a description of the artwork, and other artworks of the artist.

In one embodiment, the input image is an education content from a textbook; the digital content comprises a three dimensional image, and the digital content transforms while a student end user scans different part of textbook while reading.

In one embodiment, the input image is a cover of a book, and the digital content comprises at least one of animated contents, videos, and audios of a story of the book.

In one embodiment, the input image is a poster of a movie, and the digital content comprises at least one of a trailer of the movie, a making film, nearby movie theater, and show times of the movie in each of the nearby movie theater.

Embodiments of the inventive concept provide a business method comprising: connecting to a system at a first computer via a network; selecting data and an image corresponding to the data at the first computer; uploading the data and the image from the first computer to the system via the network; editing the data at an editor of the system; storing the edited data and the image at a memory of the system; scanning a physical depiction of the image at a second computer; submitting a query for retrieving the data corresponding to a scanned image from the physical depiction from the second computer to the system via the network; filtering the scanned image at the system; searching the data with the filtered scanned image at the system; retrieving the data at the system; fetching the data from the system to the second computer via the network, and displaying the data overlaid on the scanned image at a display of the second computer.

In one embodiment, the image is a live feed, and the data is adjusted with a rotation, a movement, and a scale with respect to a live view of the live feed.

Although the present invention is briefly summarized, the fuller understanding of the invention can be obtained by the following drawings, detailed description, and appended claims.

### BRIEF DESCRIPTION OF THE DRAWINGS

These and other features, aspects and advantages of the present invention will become better understood with reference to the accompanying drawings, wherein:

FIG. 1 is a block diagram showing a system 110 for the business method M10 according to one embodiment of the present invention.

FIG. 2 is a flow chart showing a business method M10 using augmented reality according to one embodiment of the present invention.

FIGS. 3A and 3B shows a potential client interacts with the business through a business card according to one embodiment of the present invention.

FIG. 4 shows an art appreciator interacts with a painter through the painting according to one embodiment of the present invention.

FIG. 5 shows a student learns about an educated content enhanced by digital contents according to one embodiment of the present invention.

FIG. 6 shows a potential reader learns about the book enhanced by animated digital contents through the book cover according to one embodiment of the present invention.

FIG. 7 shows potential audiences or film-goers interact with a movie distributor through a poster according to one embodiment of the present invention.

### DETAILED DESCRIPTION EMBODIMENTS OF THE INVENTIONS

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges may be expressed herein as form “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

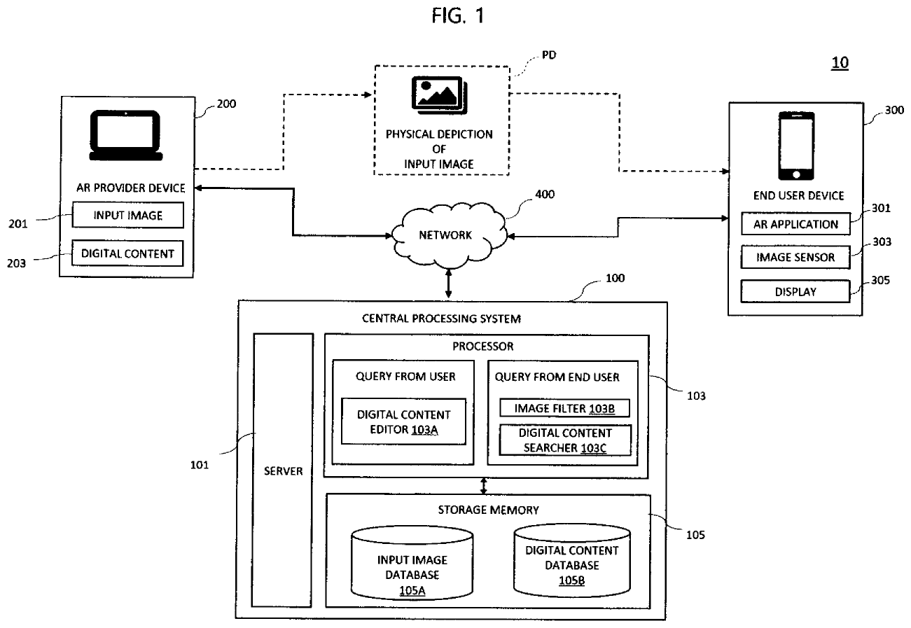

FIG. 1 is a block diagram showing a system 10 for the business method M10 using augmented reality according to one embodiment of the present invention.

According to FIG. 1, the AR platform 10 includes a central processing system 100, an AR provider device 200, an end user device 300, and a network 400. The AR platform 10 may have a plurality of AR provider devices 200, and a plurality of end user devices 300.

As used herein, the term “AR provider” refers to any person or entity who creates augmented reality through the central processing system 100, the AR provider device 200, and the network 400 to provide certain information to the target group. In some embodiments, the AR provider may be a business entity, an artist, a painter, a publisher, a newspaper company, a movie distributor, an advertisement agency, an educator, etc.

The term “end user” refers to the target group who experiences the augmented reality through the central processing system 100, the end user device 300, and the network 400. In some embodiments, the end user may be a potential client, a customer, a subscriber, a film-goer, an appreciator of art, a student, etc.

The central processing system 100 comprises a server 101, a processor 103, and a storage memory 105. The server 101 may be hosted on a cloud or a local server but is not limited to. The central processing system 100 may differentiate multiple queries from different types of the end users and can handle concurrent queries from multiple end users with a short wait time. The central processing system 100 may use compressed data transfer to speed up storing time and retrieving time.

The processor 103 may process a query from the AR provider device 200 and a query from the end user device 300. the processor 103 may be operatively connected to the storage memory 105 via an input/output circuit when it processes the queries.

To process the query from the AR provider device 200, the processor 103 may include a digital content editor 103A for editing the digital content 203 uploaded from the AR provider device 200.

Meanwhile, the processor 103 may include an image filter 103B and a digital content searcher 103C to process the query from the end user device 300. The image filter 103B may be used for getting a better image from a scanned image or a live feed by the end user device 300. The digital content searcher 103C may be used for searching digital contents corresponding to the scanned image.

The storage memory 105 may have an input image database 105A and a digital content data base 105B. The input image database 105A stores the input image 201 uploaded by the AR provider device 200. The digital content data base 105B stores the digital content 203 uploaded by the AR provider device 200.

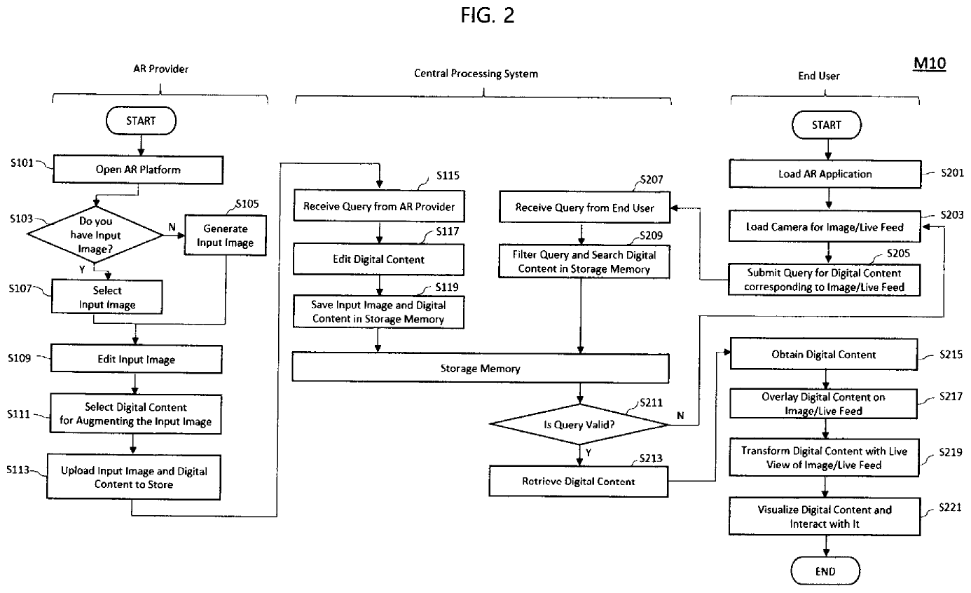

When a physical depiction PD of the input image 201 is scanned by the end user device 300, the digital content 203 corresponding to the input image 203 will be retrieved from the central processing system 100 and displayed on the input image 201. This process will be explained in more detail referring to FIG. 2.

The AR provider device 200 may be a computing device. The AR provider device 200 may store an input image 201 and a digital content 203. The input image 201 and the digital content 203 will form augmented reality or a merged image. The input image 201 may be a real world image. The input image 201 can be any image, text, a graphical object, or other identifier that can be visually depicted.

The digital content 203 may include at least one of visual content, audio content, haptic content, a real-world environment, an augmented reality environment, and any kind of content that can be operated on the electronic device. The digital content 203 may comprise any data. This process will be explained in more detail referring to FIG. 2.

The AR provider device 200 may include any electronic device, which has an operating system for accessing the central processing system 100 via the network 400 and the image databases. For example, the AR provider device 200 may be as a desktop computer, a laptop, a tablet, a smart phone, but is not limited to.

The end user device 300 has an AR application 301, an image sensor 303, and a display 305.

The end user application 305 connects the end user device 300 to the central processing system 100. The end user application 305 may perform various tasks associated with receiving information, displaying information, and transmitting information from the image sensor 303 and the display 305 of the end user device 300.

The image sensor 303 may be any kind of an image capturing system such as a camera, a webcam, a video recorder, a scanner, etc.

The display 305 may be a touch screen display using a transparent touch sensor but is not limited to.

The end user device 300 may be any electronic device, which has an operating system for the AR application 301, the image sensor 303, and the display 305. For example, the end user device 300 may be as a smart phone, a desktop computer, a laptop, a tablet, a smart watch, smart glasses, wearable electronics, but is not limited to. In some embodiments, the end user device 300 may further include Haptic System unit, Global Positioning System unit, etc.

The central processing system 100, the AR provider device 200, and the end user device 300 connect to or communicate with each other via the network 400. The network 400 may be any type of network. In some embodiments, the network 400 may be a digital network comprising internet.

FIG. 2 is a flow chart showing a business method M10 using augmented reality according to one embodiment of the present invention. The business method M10 may comprise three main sections: a creation section of digital contents by the AR provider, a storage and retrieval section of the digital contents in the central processing system, and the experience section of the digital contents by the end user.

According to FIG. 2, the creation section by the AR provider includes S101, S103, S105, S107, S109, S111, and S119. The experience section by the end user includes S201, S203, S205, S207, S209, S211, S219, and S221. The storage and retrieval section in the central processing system may overlap with either the creation section or the experience section: S115, S117, S119, S207, S209, S211, and S213.

Referring to FIGS. 1 and 2 together, the AR provider can open the AR platform 10 in his AR provider device 200 via the network 400 (S101).

The AR platform 10 determines if the AR provider device 200 has an input image 201 (S103). The AR provider may generate an input image 201 with a camera if there is no input image yet (S105). Otherwise, the AR provider can select an input image 201 from the AR provider device 200 (S107).

The input image 201 may be any image, text, graphical object, or other identifier that can be visually depicted. The identifier may include a barcode, QR code, and other textual/graphical code.

The input image 201 may be taken from a product, a service item, or any kind of medium connecting between the AR provider and the end user. For example, the input image 201 may be at least one of arts, paintings, pictures, galleries, sculptures, photography, a business card, an invitation card, posters, books, magazines, comics, advertisements, newspaper, but is not limited to.

The AR provider may be a business entity, an artist, a painter, a digital graphics artist, a publisher, a newspaper company, a movie distributor, an advertisement agency, an educator, a recruiter, but is not limited to.

Accordingly, the end user may be a potential client, a customer, a subscriber, a film-goer, an appreciator of art, a student, a new employee, but is not limited to.

In one embodiment, the business card can be used as an input image by a businessman for his potential client. In another embodiment, the picture of the product or the service item can be used as an input image 201 by the product manufacturer or the business owner for potential customers who want to learn more about the product or service.

In another embodiment, the painting can be used as an input image 201 by the painter for appreciators who want to know about the painter and/or his other paintings. In another embodiment, a movie poster can be used as an input image 201 by the movie distributor for potential audience or film-goers. In another embodiment, a book cover can be used as an input image 201 by the publisher for potential readers. In another embodiment, an educational content can be used as an input image 201 by the educator or the textbook publisher for students.

Once the input image 201 is ready, the input image 201 may be edited through the editor (S109). The input image 201 may be resized, cropped, colored, modified, etc.

Then, the digital content 203 can be selected for augmenting the input image 201 (S111). The digital content 203 may include at least one of visual content, audio content, haptic content, a real-world environment, an augmented reality environment, and any kind of content that can be operated on the electronic device and then experienced by the end user.

The visual content may include source images, virtual or digital contents, three dimensional objects, two dimensional objects, animation, video with audio, text such as AR provider details, annotation, etc. The audio content may include music, sound clips, audio recordings, etc. The real-world environment may include a map, etc. The augmented reality environment may include a navigation based on the map, a virtual art gallery, etc.

The digital content 203 may be various type of information that the AR provider wants to provide for their target group.

Referring to the embodiments mentioned above, the businessman or the manufacturer of products can provide information in forms of digital contents 203, such as the business introduction video, product demo videos, the company address with navigation details, and the website, for his potential client.

Likewise, the painter can provide information in a form of text for description of the painting or his other paintings provided as the digital contents 203.

Also, the movie distributor may provide a trailer as digital content 203 for potential audience or film-goers.

The publisher may introduce a story of the book in a form of video clip or animation for potential readers.

The educator or the textbook publisher may put educational contents like three dimensional images that can be helpful for their students to understand the concepts explained in text or two dimensional drawings.

When at least one of the digital contents 203 is selected, the input images 201 and the digital content 203 is uploaded to the central processing system 100 via the network 400 (S113).

The central processing system 100 receive query from the AR provider (S115). The query from the AR provider may include uploading the input images 201 and the digital content 203, and editing.

Once the input images 201 and the digital content 203 are unloaded in the central processing system 100, the digital content may be edited in the digital content editor 103A of the central processing system 100 (S117). The digital content 203 may be edited by adding more contents, modifying, coloring differently, resizing, and/or filtering the contents to make it rich based on the AR provider's idea. The editing process may be performed while overlaying the digital content 203 on the input image.

In other embodiments, at a first stage of the creation section, the digital content 203 may be taken as a picture or a snapshot or recorded as a video by a camera.

The input image 201 and the edited digital content 203 can be saved in the storage memory 105 of the central processing system 100 (119).

As the creation section and the storage section are finished, the digital content 203 is now set for the end user to retrieve the digital content 203 using the input image 201 via the network 400. Hereafter, the retrieval section and the experience section will be explained.

The AR Application 301 is loaded in the end user device 300 (S201). The loading step may be guided by the AR provider, but is not limited to.

An imaging sensor 303, such as a camera or a scanner, in the end user device 300 may be loaded for scanning an image or getting a live feed (S203).

The end user may scan a printed image or get a live feed that is marked or known as an input image 201. The printed image or the live feed is a physical depiction of the input image 201.

This physical depiction of the input image 201 can be delivered from the AR provider to the end user in person but is not limited to. In some embodiments, the physical depiction of the input image 201 may be displayed or exhibited in public space or private space. In other embodiments, the physical depiction of the input image 201 may be put in any kind of publications.

Once the image sensor 303 catches the image or the live feed, the end user device 300 submits a query for a digital content 203 corresponding to the image or the live feed (S205).

When the central processing system 100 receive the query from the end user device 300 (S207), the system 100 filters the query by the image filter 103B and searches the digital contents 203 corresponding to the image or the live feed in the storage memory 105 by the digital content searcher 103C(S209).

If the query is valid, the system 100 retrieves the digital contents 203 from the storage memory 105 (S213) and sends it back to the end user device 300 via the network 400.

The end user device 300 obtains the digital contents 203 from the system 400 (S215) and overlays the digital contents 203 on top of the image or the live feed (S217). In this case, the end user device 300 may transform the digital contents 203 with live view of the image or the live feed (S219). Specifically, the digital contents 203 may be adjusted with a rotation, a movement, and a scale with respect to the live view of the imaging sensor 303, which matches with the end user's perception. This may create a seamless viewing experience. The live feed may be fed from a live camera such as a smartphone camera, a web camera, or a video file.

Then, the digital contents 203 overlaid on the image or the live feed are visualized on a display 305 of the end user device 300 (S221). The end user may interact with the augmented reality by tapping, scrolling, and/or swiping the digital contents 203 displayed on the screen of the display 305.

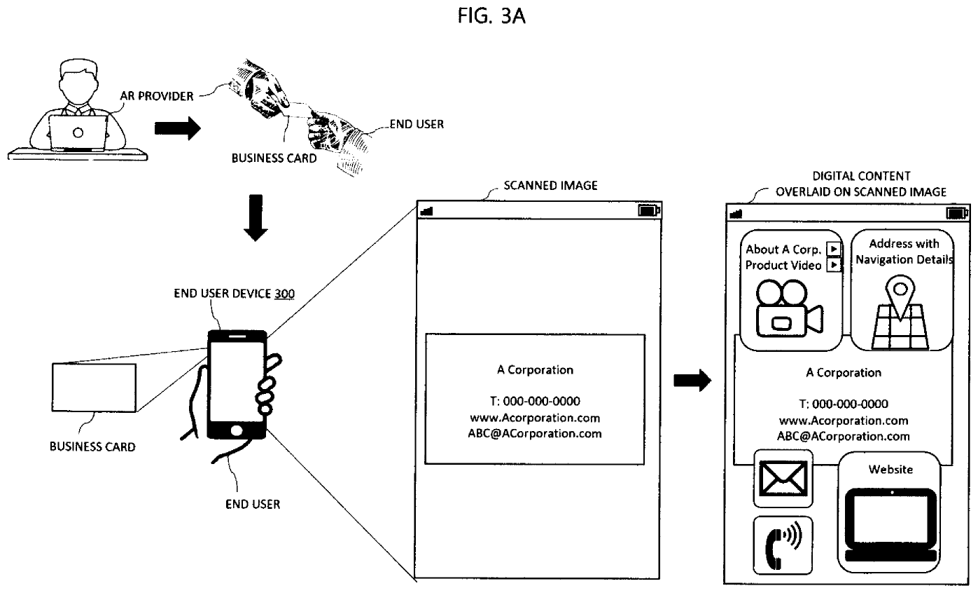

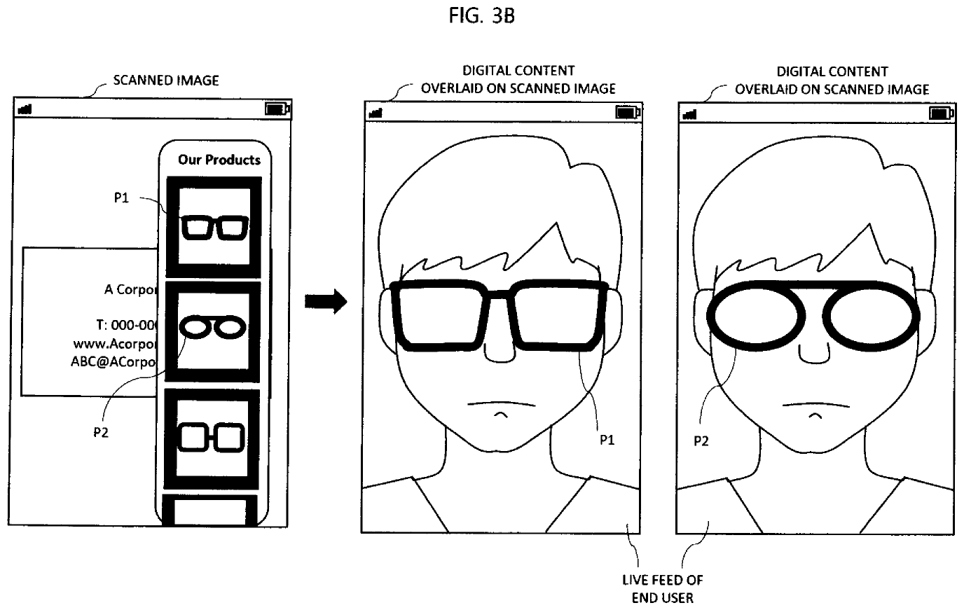

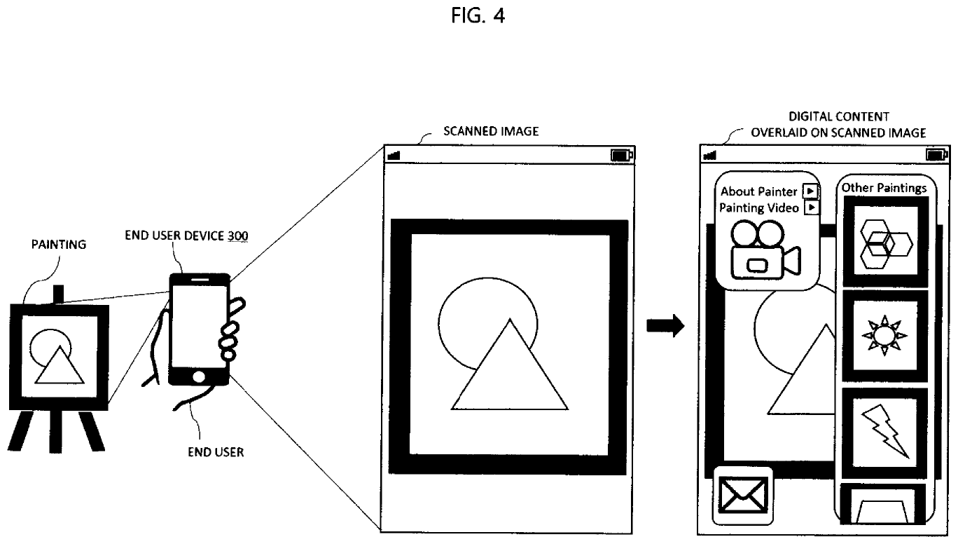

The AR platform may be used for business, marketing, advertising, remote online education, personal purposes, but not limited to. FIGS. 3 to 4 show some embodiments of the present invention.

FIGS. 3A and 3B shows a potential client interacts with the business through a business card according to one embodiment of the present invention.

Referring to FIG. 3A, when a business owner, as an AR provider, can create digital contents according to the business method M10 described in FIGS. 1 and 2. The digital contents may include business introduction videos, product demo videos, an address with navigation details, direct contacts, an email, and a company website. His business card may be set as an input image corresponding to the digital contents.

The business owner can give his business card to his potential client. Then, the potential client who wants to learn more about the business, can load the AR application in his device, participate in the AR platform 10 as an end user, and scan the business card.

Then, the central processing system retrieves the digital contents, which were created and stored by the business owner. The end user device obtains the retrieved digital contents (e.g. business introduction videos, product demo videos, an address with navigation details, direct contacts, an email, and a company website) and visualizes it to be overlaid on the business card. Also, the end user can experience product and service demonstrations, especially in e-commerce such as trying on glasses, clothes, jewelry, makeup, or furniture in a home.

Referring to FIG. 3B together, the glasses seller, the AR provider, can show their glasses P1, P2 as digital contents, and the end user can try on the glasses P1, P2 by overlaying them on the live feed of the end user.

Accordingly, the potential client can obtain a new and lively experience from this augmented reality as well as learning accurate information about the business or the products.

FIG. 4 shows an art appreciator interacts with a painter through his painting according to one embodiment of the present invention

Referring to FIG. 4, when a painter, as an AR provider, can create digital contents according to the business method M10 described in FIGS. 1 and 2. The digital contents may include an introduction video about the painter, a painting video, a text for description of the painting provided as the input image, and/or his other paintings. His painting may be set as an input image corresponding to the digital contents.

The painter may display his painting in a gallery, public space, or private space for appreciators.

The appreciator of the painting who wants to learn more about the painter or the painting, can load the AR application in his device, participate in the AR platform 10 as an end user, and scan the painting.

Then, the central processing system retrieves the digital contents, which were created and stored by the painter. The end user device obtains the retrieved digital contents, the introduction video about the painter, the painting video, the description of the painting, and/or his other paintings, and visualizes it to be overlaid on the painting.

Accordingly, the appreciator can obtain a new and lively experience from this augmented reality as well as learning accurate information about the painting.

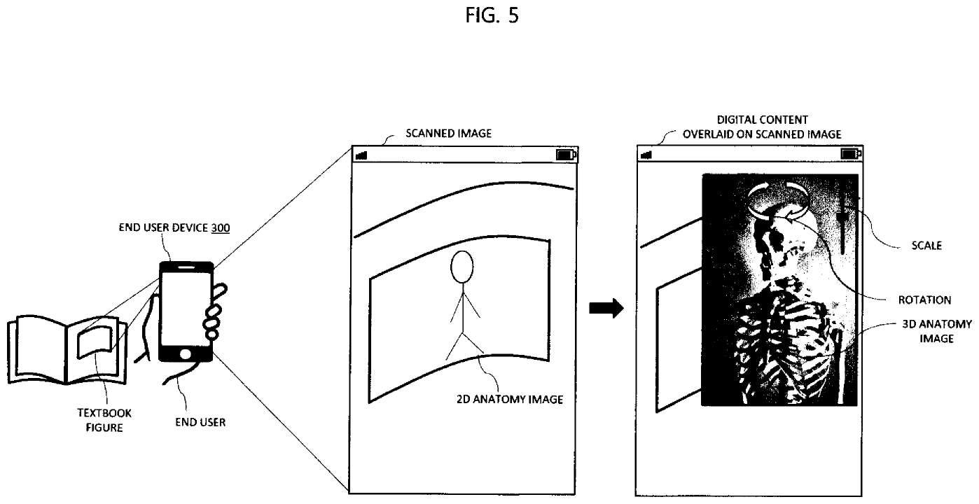

FIG. 5 shows a student learn more easily about an educated content enhanced by digital content according to one embodiment of the present invention.

Referring to FIG. 5, when an educator or the textbook publisher, as an AR provider, can create educational digital contents like three dimensional images for their students. The text or a two dimensional drawing may be set as an input image corresponding to the digital contents.

The student can participate in the AR platform 10 as an end user and scan the text or the two dimensional drawing. Then, the end user device obtains the three dimensional images to be overlaid on the textbook.

Accordingly, the student can understand difficult concepts, such as anatomy or space science, easily and precisely, which often require space perception ability.

Also, the student can obtain a vivid and lively experience as the student can interact with the digital contents by exploring, rotating, or zooming the digital content while reading the textbook. Furthermore, the digital content transforms while a student end user scans different part of the textbook while reading.

Likewise, in another embodiment, when a recruiter or a predecessor, as an AR provider, can create digital contents for hiring, recruiting, or onboarding new employees.

In some embodiments, other types of remote online education beyond children or school also may use the AR platform 10. For example, an educator provider, an AR provider, can create digital contents for a corporate learning or an adult life-long learning such as how to cook, paint, teach your pet a trick, learn a new skill or books like the Bible.

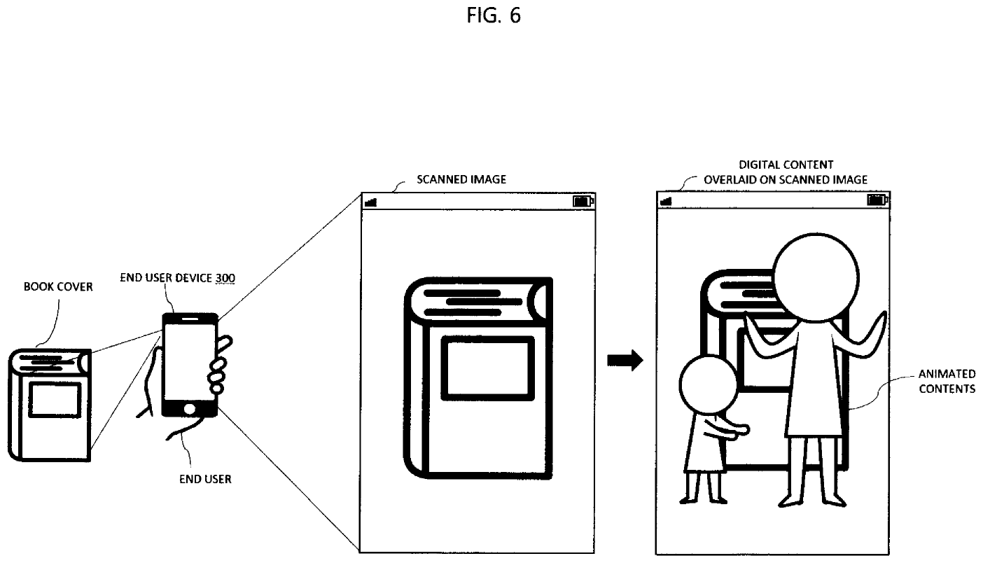

FIG. 6 shows a potential reader learn about the book enhanced by animated digital content through the book cover according to one embodiment of the present invention.

Referring to FIG. 6, when the publisher, as an AR provider, can create a story of the book in a form of video clip or animation for potential readers. The book cover may be set as an input image corresponding to the digital contents.

The potential reader can participate in the AR platform 10 as an end user and scan the book cover. Then, the end user device obtains the animated digital content to be overlaid on the book cover. Accordingly, the potential reader can learn about a story from this augmented reality and be attracted to the book.

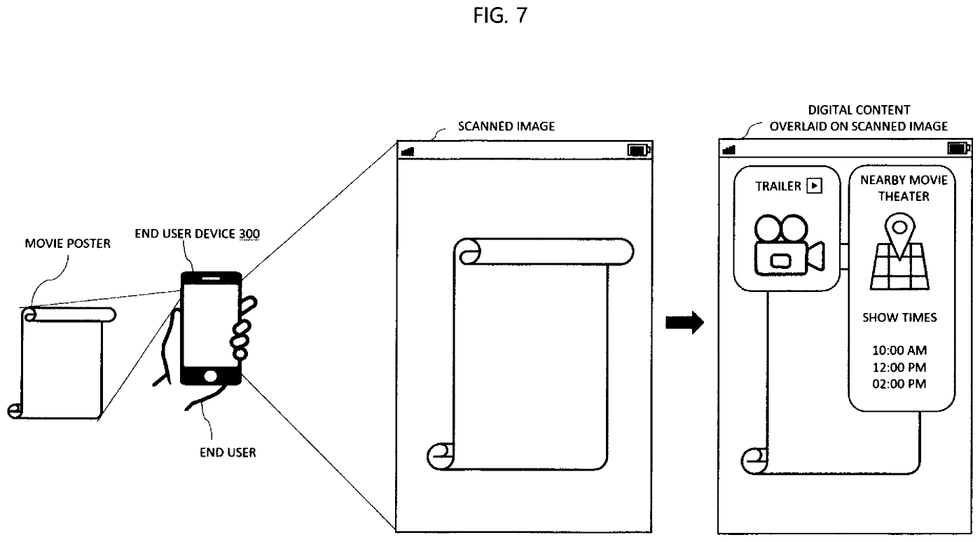

FIG. 7 shows potential audiences or film-goers interact with a movie distributor through a poster according to one embodiment of the present invention.

Referring to FIG. 7, when the movie distributor, as an AR provider, can create digital contents according to the business method M10 described in FIGS. 1 and 2. The digital contents may include a trailer, a making film, or nearby movie theaters, and show times of each movie theater. The movie poster may be set as an input image corresponding to the digital contents.

The potential audiences or film-goers can load the AR application in his device, participate in the AR platform 10 as an end user, and scan the movie poster.

Then, the central processing system retrieves the digital contents. The end user device obtains the retrieved digital contents and visualizes it to be overlaid on the movie poster.

Likewise, when a marketer or an advertiser, as an AR provider, can use enhanced ads, such as Facebook, Instagram, or YouTube, and/or promotions. Also, a marketer or an advertiser can enhance images of product or service with various kinds of digital contents such as music video from artists.

The present invention also can be used for personal purposes. For example, an individual, as an AR provider, can create customized digital contents for his or her resume, greeting cards such as birthday cards, get well soon cards, congratulation cards, etc.

The AR platform 10 according to the present invention may expand to include any open sources or platforms.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A business method using augmented reality, the business method comprising:
uploading a digital content and an input image corresponding to the digital content from an AR provider device to a central processing system via a network;
storing the digital content and the input image at a storage memory of the central processing system;
scanning a physical depiction of the input image at an image sensor of an end user device;
submitting a query for retrieving the digital content corresponding to a scanned image from the physical depiction of the input image from the end user device to the central processing system via the network;
retrieving the digital content at the central processing system;
fetching the digital content from the central processing system to the end user device via the network, and
displaying the digital content overlaid on the scanned image at a display of the end user device.

2. The business method of claim 1,
wherein, between the uploading and the storing, the method further comprises:
editing the digital content at an editor of the central processing system.

3. The business method of claim 2,
wherein the editing comprises at least one of adding more contents, modifying, coloring, resizing, and filtering the digital content.

4. The business method of claim 2,
wherein the editing is performed while overlaying the digital content on the input image.

5. The business method of claim 1,
wherein, between the receiving the query and the retrieving the digital content, the method further comprises:
filtering the scanned image of the query at the central processing system, and
searching the digital content with the filtered scanned image at the central processing system.

6. The business method of claim 1,
wherein the central processing system process both a query from the AR provider and the query from the end user device.

7. The business method of claim 1,
wherein the central processing system, the image sensor, and the display are connected to each other through an AR application loaded on the end user device.

8. The business method of claim 1,
wherein the displaying further comprises interacting with, exploring, rotating, and zooming the digital content by tapping, scrolling, and swiping the display.

9. The business method of claim 1,
wherein the input image is a real world image comprising at least one of arts, paintings, pictures, galleries, sculptures, photography, a business card, an invitation card, posters, books, magazines, comics, advertisements, and newspaper.

10. The business method of claim 1,
wherein the input image is a live feed.

11. The business method of claim 1,
wherein the digital content comprises at least one of visual content, audio content, haptic content, a real-world environment, and an augmented reality environment.

12. The business method of claim 10,
wherein the digital content comprises at least one of a virtual or digital content, a three dimensional object, two dimensional object, animation, a video with audio, text, annotation, music, sound clips, audio recordings, a map, a navigation map, and a virtual art gallery.

13. The business method of claim 1,
wherein the digital content is adjusted with a rotation, a movement, and a scale with respect to a live view of the imaging sensor.

14. The business method of claim 1,
wherein the input image is at least one of a business card and an item used for business, and
wherein the digital content comprises at least one of business introduction videos, product demo videos, product images, an address with navigation details, a direct contact, an email, and a company website.

15. The business method of claim 1,
wherein the end user experiences products by overlaying the products images on a live feed of the end user.

16. The business method of claim 1,
wherein the input image is an artwork, and
wherein the digital content comprises at least one of an introduction video about an artist of the artwork, an artwork making video, a description of the artwork, other artworks of the artist, animated contents, and an audio of a story of the artwork.

17. The business method of claim 1,
wherein the input image is an education content;
wherein the digital content comprises at least one of a two dimensional image, animated contents, a three dimensional image and a video.

18. The business method of claim 1,
wherein the input image is a poster of a movie, and
wherein the digital content comprises at least one of a trailer of the movie, a making film, nearby movie theater, and show times of the movie in each of the nearby movie theater.

19. A business method using augmented reality, the business method comprising:
connecting to a system at a first computer via a network;
selecting data and an image corresponding to the data at the first computer;
uploading the data and the image from the first computer to the system via the network;
editing the data at an editor of the system;
storing the edited data and the image at a memory of the system;
scanning a physical depiction of the image at a second computer;
submitting a query for retrieving the data corresponding to a scanned image from the physical depiction from the second computer to the system via the network;
filtering the scanned image at the system;
searching the data with the filtered scanned image at the system;
retrieving the data at the system;
fetching the data from the system to the second computer via the network, and
displaying the data overlaid on the scanned image at a display of the second computer.

20. The business method of claim 19,
wherein the image is a live feed, and
wherein the data is adjusted with a rotation, a movement, and a scale with respect to a live view of the live feed.
